(19) United States
(12) Patent Application Publication
(10) Pub. No.: US 2015/0348400 A1
(43) Pub. Date: Dec. 3, 2015

(54) LEARNING ALARMS FOR NUISANCE AND FALSE ALARM REDUCTION

(71) Applicant: Carrier Corporation, Farmington, CT (US)

(72) Inventors: Anis Zribi, Farmington, CT (US); Stan Burnette, Farmington, CT (US); Bill Chandler, Farmington, CT (US)

(21) Appl. No.: 14/722,363

(22) Filed: May 27, 2015

Related U.S. Application Data
(60) Provisional application No. 62/006,997, filed on Jun. 3, 2014.

(51) Int. Cl. G08B 29/18

(52) U.S. Cl. CPC G08B 29/185

(57) ABSTRACT

A learning alarm includes a sensor operatively connected to a processor to detect environmental properties and an alarm operatively connected to the processor to provide an alert if the environmental properties are outside an acceptable range. A user interface is operatively connected to the processor to accept user input indicating an alert corresponds to a nuisance condition. A memory is also operatively connected to the processor for storing detected environmental properties corresponding to the nuisance condition. The processor is configured to suppress alerts from the alarm based on detected environmental properties corresponding to the environmental properties of the nuisance condition stored in the memory.

### CROSS-REFERENCE TO RELATED APPLICATION

This application claims the benefit of priority under 35 U.S.C. §119(e) to U.S. Provisional Application No. 62/006,997, filed Jun. 3, 2014, which is incorporated herein by reference in its entirety.

### BACKGROUND OF THE INVENTION

1. Field of the Invention

The present invention relates generally to individual alarms and alarm systems. More specifically, the present invention relates to alarms and alarm systems, e.g., for detecting hazards in residential, commercial and industrial applications such as smoke, toxic or explosive gases.

2. Description of Related Art

There has been remarkable growth in the usage of home smoke detectors, principally single-station, battery-operated, ionization-mode smoke detectors. This rapid growth, coupled with clear evidence in actual fires and fire statistics of the lifesaving effectiveness of detectors, made the home smoke detector a fire safety success.

In recent years, however, studies of the operational status of smoke detectors in homes revealed that as many as one-fourth to one-third of smoke detectors are nonoperational at any one time. Over half of the nonoperational smoke detectors are attributable to missing batteries. The rest is due to dead batteries and nonworking smoke detectors. Research showed the principal cause of the missing batteries was homeowner's frustration over nuisance alarms, which are caused not by accidental, unwanted fires but by controlled fires, such as cooking flames. These nuisance or false alarms are also caused by nonfire sources, such as steam emanating from a bathroom shower, dust or debris stirred up during cleaning, or oil vapors escaping from a kitchen.

Centralized fire detection systems also play an important role in protecting the occupants of commercial and industrial buildings. False alarms are detrimental in this setting as well, not only causing inconvenience to building occupants but also potentially creating a dangerous lack of confidence in the validity of future alarms.

Smoke alarms are equipped with hush buttons which simply allow a user to temporarily reduce the alarm sensitivity during a nuisance or false alarm event. However, it is common for the hush button to have to be pressed repeatedly during a single nuisance event. It is possible that the user may decide to disable the alarm altogether rather than deal with nuisance alarms.

Such conventional methods and systems have generally been considered satisfactory for their intended purpose. However, there is still a need in the art for improved device and method for reducing false alarms. The present disclosure provides a solution for this need.

### SUMMARY OF THE INVENTION

In one aspect of the invention a learning alarm includes a sensor operatively connected to a processor to detect environmental properties and an alarm operatively connected to the processor to provide an alert if the environmental properties are outside an acceptable range. A user interface is operatively connected to the processor to accept user input indicating an alert corresponds to a nuisance condition. A memory is also operatively connected to the processor for storing detected environmental properties corresponding to the nuisance condition. The processor is configured to suppress alerts from the alarm based on detected environmental properties corresponding to the environmental properties of the nuisance condition stored in the memory.

The processor can be configured to compare the detected environmental properties with environmental properties from a plurality of stored nuisance conditions. The processor can also be operative to override suppression of the alerts in the presence of environmental properties outside of a predetermined range.

In certain embodiments, the nuisance condition includes a property selected from the group consisting of gas concentration, gas composition, humidity, and temperature. The nuisance condition may also include smoke concentration and composition.

In another aspect of the invention a learning alarm system includes a processor operatively connected to at least two alarm units. Each alarm unit includes a sensor to detect environmental properties. An alarm is operatively connected to the processor to provide an alert if the environmental properties are outside an acceptable range. A user interface is operatively connected to the processor to accept user input indicating an alert corresponds to a nuisance condition. A memory is operatively connected to the processor for storing detected environmental properties corresponding to the nuisance condition detected from each alarm. The processor is configured to suppress alerts from the alarm based on detected environmental properties corresponding to the environmental properties of the nuisance condition stored in the memory.

A control panel can be operatively connected to the processor for monitoring the at least two alarms.

A method of suppressing nuisance alarms is also provided. The method first includes detecting a condition. Next, the detected condition is compared with at least one nuisance condition stored in memory. An alert is provided if the condition is outside an acceptable range and if the condition does not correspond to a nuisance condition. In addition, the alert is suppressed if the condition corresponds to a nuisance condition.

In certain embodiments the method can include accepting user input to indicate the condition is a nuisance condition and storing the nuisance condition in memory. The method can also include overriding suppression of the alert when the condition is outside a predetermined range.

It is also contemplated that the step of comparing can include comparing a slope of a curve of the detected condition and a slope of a curve of the at least one nuisance condition. The step of comparing may also include comparing a rate of rise of the detected condition and a rate of rise of the at least one nuisance condition. The step of comparing may further include comparing a shape of a curve of the detected condition and a shape of a curve of the at least one nuisance condition using curve fitting techniques.

In other embodiment, the condition includes a property selected from the group consisting of gas concentration, gas composition, humidity, and temperature. The condition may also include smoke concentration and composition.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a learning alarm constructed in accordance with the present disclosure;

FIG. 2 is a graphical representation of suppressible and non-suppressible environmental parameters concentration ranges detected using the learning alarm of FIG. 1;

FIG. 3 is a schematic view of learning alarm system having two learning alarm units of FIG. 1; and

FIG. 4 is a flow chart showing the method of suppressing nuisance alarms using the learning alarm of FIG. 1.

### DETAILED DESCRIPTION OF THE PREFERRED EMBODIMENTS

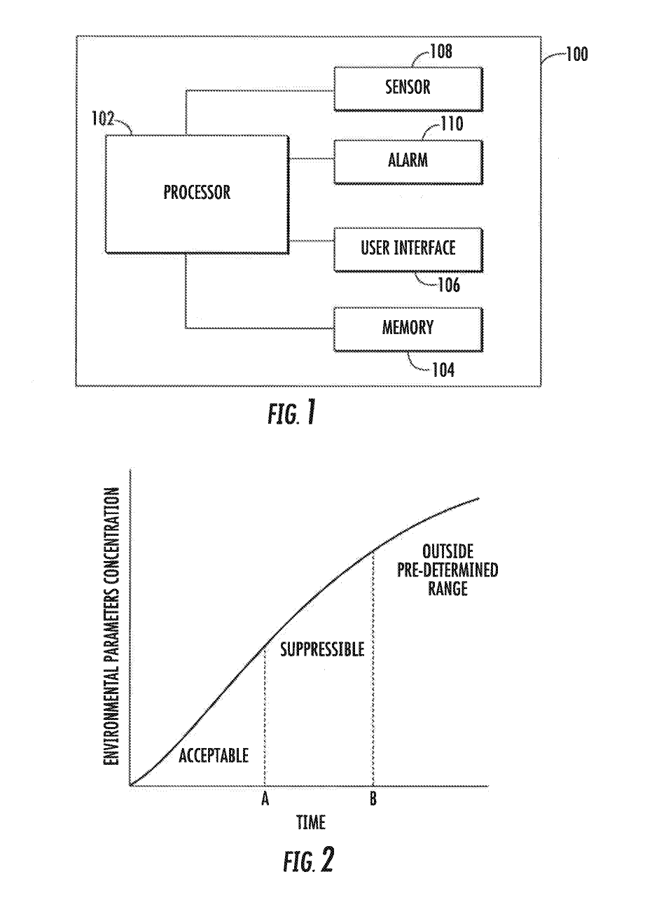

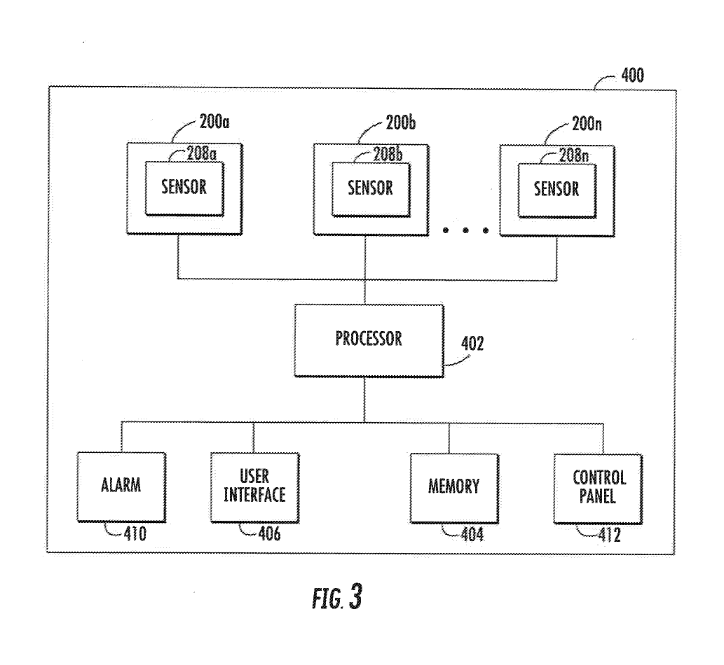

Reference will now be made to the drawings wherein like reference numerals identify similar structural features or aspects of the subject disclosure. For purposes of explanation and illustration, and not limitation, a partial view of an exemplary embodiment of the learning alarm in accordance with the disclosure is shown in FIG. 1 and is designated generally by reference character 100. Other embodiments of learning alarms in accordance with the disclosure, or aspects thereof, are provided in FIGS. 2-3, as will be described. The systems and methods described herein can be used to diminish the occurrence of alerts from alarms during nuisance events.

With reference to FIG. 1, a learning alarm 100 in accordance with the present invention is shown schematically. The learning alarm 100 utilizes a processor 102 and a memory 104 working in conjunction to diminish the occurrence of nuisance events/false alarms over time. Several smoke detectors can be installed in a residential space to alert the occupants when a relatively high amount of smoke is detected, for example. However, in many instances, the smoke may be the result of a safe, controlled activity, in other words, the alert under such conditions is a false alarm. False alarms can be caused by cooking flames, a spike in heat and humidity due to steam from a shower and/or dust or debris circulated during cleaning, or the like. In traditional alarms, to stop the alert of the smoke detector, the occupant has to silence the alarm manually or in extreme cases dismantle the smoke detector.

The learning alarm 100 of the present invention stores the characteristics of the false alarm/nuisance event in real time. When a nuisance event occurs, a user silences the learning alarm 100 through a user interface 106, e.g., by pressing a hush button. The memory 104 of the alarm 100 stores characteristics of detected properties, e.g., smoke properties, at the time the nuisance event occurs.

The alarm 100 has a sensor 108 operatively connected to the processor 102 to detect environmental properties. It is to be understood that the sensor is shown and described to detect various environmental properties, for example, CO₂ gas concentrations, which are generally associated with fires. The sensor 108 may also be associated with detecting temperature, humidity, and smoke concentration and composition. It is also contemplated that the systems and methods described herein can be adapted to non-smoke application such as in CO alarms for hazardous gases.

Once the sensor 108 detects environmental properties outside an acceptable range, an alarm 110 operatively connected to the processor alerts the occupant of the detected hazard. In instances when the alarm 110 issues an alert during controlled circumstances constituting a nuisance alert, the occupant silences the alarm through the user interface 106 operatively connected to the processor 102 indicating the alarm was activated during a nuisance condition. The memory 104 operatively connected to the processor stores the detected environmental properties corresponding to the nuisance condition. More specifically, the memory 104 stores the environmental concentration and characteristics detected over a period of time as a waveform with the increase and decrease in environmental parameter concentration.

At a later time when the sensor 108 detects environmental properties, the processor 102 is configured to suppress alerts from the alarm 110 based on detected environmental properties corresponding to the environmental properties of the nuisance condition stored in memory 104. Over time a plurality of nuisance condition characteristics will accumulate in the memory 104. The processor 102 will compare each occurrence of hazard detection by the sensor 108 with a plurality of the nuisance conditions to suppress alerts when the detected environmental properties correspond to a known nuisance condition.

In addition, the processor is operative to override suppression of alerts in the presence of environmental properties outside of a pre-determined range. For example, if the detected property lies outside of a pre-determined safe range the alert suppression will be over-ridden by the processor and an alert will issue. FIG. 2 illustrates graphically ranges in which the alert can be suppressed either via user input or after comparison to a stored nuisance condition and when the alert is overridden. As shown in FIG. 2 as the environmental parameters concentration increases past an acceptable range, the alert can be suppressed either via user input or after comparison to a stored nuisance event. However, once the environmental parameters concentration increases past a pre-determined safe range, suppression of the alert is overridden and the alarm will sound. In this manner, alarm 100 learns to discriminate between real hazardous conditions and a nuisance event. This significantly lowers the frequency of false alarms/nuisance events and the associated likelihood that an occupant will disable the alarm entirely. FIG. 1 illustrates the alarm 100 schematically, however it will be understood that the features of alarm 100 can be included in a housing, similar to smoke detectors as known in the art.

With reference now to FIG. 3, an alarm system 400, is shown for use. The system 400 has at least two alarms 200a, 200b in a residential, commercial or industrial building, or the like. As shown in FIG. 2, each alarm 200a, 200b has a sensor 208a, 208b to detect environmental properties within the vicinity of the individual sensor 208a, 208b. Each sensor 208a, 208b is operatively connected to the processor 402. In addition, an alarm 410 to provide an alert, a user interface 406 to accept user input, and a memory 404 to store detected environmental properties are operatively connected to a processor 402. The processor 402 is operatively connected to a control panel 412, e.g., a central panel for controlling and monitoring sensors throughout a large building. In this system 400 when a nuisance condition is identified with sensor 208a, the alert can be suppressed through the control panel 412. The characteristics of the nuisance condition are stored in memory 404. If an environmental property is later detected at sensor 208b, the characteristics are compared to the plurality of nuisance conditions stored in memory 404. Thus, a nuisance condition sensed by sensor 208a will cause suppression of the alarm 410 if a similar nuisance condition is sensed by sensor 208b. In other words, the stored characteristics of nuisance conditions in memory 404 from each sensor 208a, 208b are used to determine if a subsequently sensed environmental parameter concentration is within an acceptable range. This further provides a greater database of nuisance condition characteristics to diminish nuisance events. To allow system 400 to learn which conditions correspond to a nuisance condition, a user can provide hush input at panel 412 whenever a nuisance condition arises, such as described above in FIG. 1.

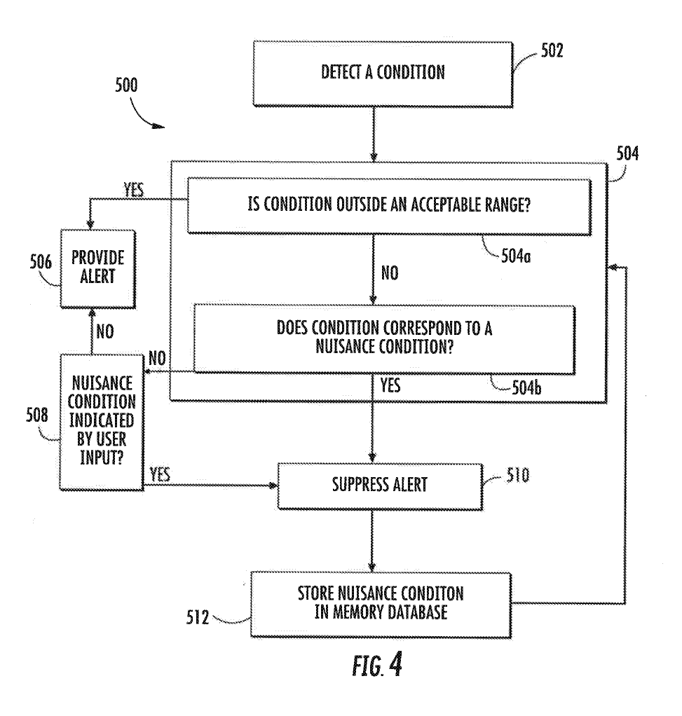

FIG. 4 illustrates a method 500 of suppressing alarms during a nuisance condition using the learning alarm 100 of FIG. 1. The method steps comprise first detecting a condition at step 502. The condition includes gas concentration or composition, particle concentration or composition, humidity, and temperature.

The detected condition is next compared at step 504 with conditions outside an acceptable range 504a. If the condition is outside an acceptable range then the alert will be provided at step 506. If the detected condition is within an acceptable range, the condition is compared with at least one nuisance condition stored in memory, e.g., memory 104, 504b. If the detected condition does correlate to a stored nuisance condition, the alert is suppressed in step 510.

When the detected condition does not correlate with at least one stored nuisance condition, a processor, e.g., processor 102, determines if the alert was suppressed by user input 508. If yes, the alert is suppressed at step 510. If no, the alert is provided at step 506.

At step 512 when the condition is suppressed either because of user input or by comparison to stored nuisance conditions, memory stores the real-time nuisance condition. Memory 104 stores each nuisance condition as a waveform indicating the increase and decrease of the detected concentration and atmospheric characteristics detected over a period of time. The step of comparing includes comparing the slope of the curve of the detected condition and the slope of the curve of the at least one nuisance condition. The step of comparing may also include comparing the rate of rise of the detected condition and the rate of rise of the at least one nuisance condition. Those skilled in the art will appreciate that the method depicted in FIG. 3 can readily be adapted to the system 400 shown in FIG. 2 as well.

The methods and systems of the present disclosure, as described above and shown in the drawings, provide for a learning alarm with superior properties including a learning alarm that can discriminate between real hazardous conditions and a nuisance event. This significantly lowers the frequency of false alarms/nuisance events and the associated likelihood that an occupant will disable the alarm entirely.

While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A learning alarm, comprising:
a sensor operatively connected to a processor to detect environmental parameters;
an alarm operatively connected to the processor to provide an alert if the environmental parameters are outside an acceptable range;
a user interface operatively connected to the processor to accept user input indicating an alert corresponds to a nuisance condition; and
a memory operatively connected to the processor for storing detected environmental properties corresponding to the nuisance condition,
wherein the processor is configured to suppress alerts from the alarm based on detected environmental properties corresponding to the environmental properties of the nuisance condition stored in the memory.

2. The alarm of claim 1, wherein the processor is configured to compare the detected environmental properties with environmental properties from a plurality of stored nuisance conditions.

3. The alarm of claim 1, wherein the nuisance condition includes a property selected from the group consisting of gas concentration, gas composition, humidity, and temperature.

4. The alarm of claim 1, wherein the nuisance condition includes smoke concentration and composition.

5. The alarm of claim 1, wherein the processor is operative to override suppression of the alerts in the presence of environmental properties outside of a predetermined range.

6. A learning alarm system, comprising:
a processor operatively connected to at least two alarm units, each alarm unit including a sensor to detect environmental properties;
an alarm operatively connected to the processor to provide an alert if the environmental properties are outside an acceptable range;
a user interface operatively connected to the processor to accept user input indicating an alert corresponds to a nuisance condition; and
a memory operatively connected to the processor for storing detected environmental properties corresponding to the nuisance condition detected from each alarm,
wherein the processor is configured to suppress alerts from the alarm based on detected gas properties corresponding to the gas properties of the nuisance condition stored in the memory.

7. The system of claim 6, wherein the processor is configured to compare the detected environmental properties with environmental properties from a plurality of stored nuisance conditions.

8. The system of claim 6, wherein the nuisance condition includes a property selected from the group consisting of gas concentration, gas composition, humidity, and temperature.

9. The system of claim 6, wherein the nuisance condition includes smoke concentration and composition.

10. The system of claim 6, wherein the processor is operative to override suppression of the alerts in the presence of environmental properties outside of a predetermined range.

11. A method of suppressing nuisance alarms, comprising:
detecting a condition;
comparing the condition with at least one nuisance condition stored in memory;
providing an alert if the condition is outside an acceptable range and if the condition does not correspond to a nuisance condition; and
suppressing an alert if the condition corresponds to a nuisance condition.

12. The method as recited in claim 11, further comprising:
accepting user input to indicate the condition is a nuisance condition; and
storing the nuisance condition in memory.

13. The method as recited in claim 11, wherein the step of comparing includes comparing a slope of a curve of the detected condition and a slope of a curve of the at least one nuisance condition.

14. The method as recited in claim 11, wherein the step of comparing includes comparing a rate of rise of the detected condition and a rate of rise of the at least one nuisance condition.

15. The method as recited in claim 11, wherein the step of comparing includes comparing a shape of a curve of the detected condition and a shape of a curve of the at least one nuisance condition using curve fitting techniques.

16. The method of claim 11, wherein the condition includes a property selected from the group consisting of gas concentration, gas composition, humidity, and temperature.

17. The method as recited in claim 11, wherein the condition includes smoke concentration and composition.

18. The method as recited in claim 11, further comprising:
overriding suppression of the alert when the condition is outside a predetermined range.
